(19) United States
(12) Patent Application Publication
(10) Pub. No.: US 2019/0041856 A1
(43) Pub. Date: Feb. 7, 2019

(54) METHODS AND APPARATUS TO CAPTURE TOMOGRAMS OF STRUCTURES USING UNMANNED AERIAL VEHICLES

(71) Applicant: Intel IP Corporation, Santa Clara, CA (US)

(72) Inventors: Andreas Hippelein, Munich (DE); Daniel Pohl, Puchheim (DE)

(21) Appl. No.: 15/805,953

(22) Filed: Nov. 7, 2017

(51) Int. Cl. G05D 1/00; G06K 9/00; G01M 5/00; B64C 39/02; G08G 5/00; G05D 1/10

(52) U.S. Cl. CPC G05D 1/0094; G06K 9/00637; G01M 5/0025; B64C 2201/127; G08G 5/0069; G05D 1/104; B64C 2201/123; B64C 39/024

(57) ABSTRACT

Methods and apparatus to capture tomograms of structures using unmanned aerial vehicles are disclosed. An example apparatus includes a flight controller, implemented by at least one processor, to control a first unmanned aerial vehicle adjacent to a structure. The example apparatus further includes a first tomography device mounted to the first unmanned aerial vehicle. The first tomography device is to at least one of (a) transmit tomography waves to or (b) detect tomography waves from a second tomography device mounted on a second unmanned aerial vehicle to generate a tomogram of the structure.

### FIELD OF THE DISCLOSURE

This disclosure relates generally to unmanned aerial vehicles, and, more particularly, to methods and apparatus to capture tomograms of structures using unmanned aerial vehicles.

### BACKGROUND

In recent years, many applications for unmanned aerial vehicles (UAVs) have developed. One significant application for UAVs is the visual inspection of structures such as buildings and bridges. In such applications, a UAV may be controlled (either autonomously or manually) to the vicinity of the structure to be inspected and a sensor (e.g., a camera) on the UAV may then capture images of the structure for review and/or analysis. For example, the images may be reviewed to identify cracks, fractures, or other potential failures that may need fixing.

### BRIEF DESCRIPTION OF THE DRAWINGS

FIG. 1 illustrates two example UAVs constructed in accordance with the teachings disclosed herein capturing tomograms of an example structure.

FIGS. 2 and 3 illustrate alternative example flight paths followed by the example UAVs of FIG. 1 to capture tomograms of the example structure of FIG. 1.

FIGS. 4 and 5 illustrate alternative example positions for the tomography wave generator and the example tomography wave detector on the UAVs of FIGS. 1-3.

FIG. 6 illustrates example arms attached to one of the example UAVs of FIGS. 1-5 to facilitate visual detection of the UAV by the second UAV.

FIG. 7 is a block diagram illustrating an example implementation of the example UAVs of FIG. 1-6.

FIG. 8 is flowchart representative example machine readable instructions that may be executed to implement the example UAVs of FIGS. 1-7.

FIG. 9 illustrates an example processor platform that may execute the example instructions of FIG. 8 to implement the example UAVs of FIGS. 1-7.

The figures are not to scale. Wherever possible, the same reference numbers will be used throughout the drawing(s) and accompanying written description to refer to the same or like parts.

### DETAILED DESCRIPTION

While a visual inspection of the exterior of a structure using photographs of the structure may be beneficial to detect some damage, wear, and/or potential failure points (cracks, fractures, etc.), such photographs are incapable of representing internal damage or failure points inside the structure. Damage or failure points inside a structure may be just as critical or dangerous as external structural damage. Examples disclosed herein enable the scanning of inside of structures using tomography techniques to capture images (e.g., tomograms) that represent the structural integrity of objects, both on the inside and on the outside. More particular, in some examples, a first UAV (also known as a drone) is equipped with a tomography wave generator and a second UAV is equipped with a tomography wave detector. Both the tomography wave generator and the tomography wave detector are generally referred to herein as tomography devices. As described more fully below, both UAVs are autonomously controlled to opposite sides of the structure to be imaged and positioned so that tomography waves (e.g., x-rays) from the tomography wave generator (on the first UAV) pass through the structure and are received at the tomography wave detector (on the second UAV). While x-rays are one example type of tomography waves that may be used to generate tomograms (e.g., x-ray images), as used herein, tomography waves refer to any type of waves that are capable of passing through a structure and being detected by a tomography device.

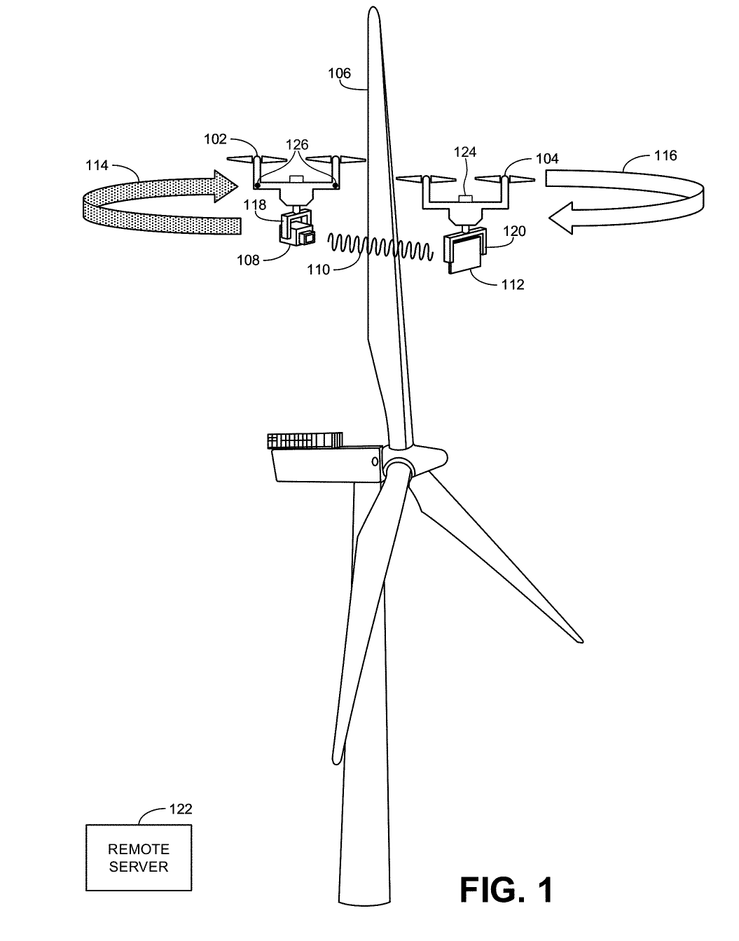

FIG. 1 illustrates two example UAVs 102, 104 constructed in accordance with the teachings disclosed herein capturing tomograms of an example structure 106. In the illustrated example, the first UAV 102 is equipped with or carrying a tomography wave generator 108 configured to produce tomography waves 110 in a specified direction. Thus, the first UAV 102 is sometimes referred to herein as a tomography wave generating UAV. The second UAV 104 of the illustrated example is equipped with or carrying a tomography wave detector 112 to detect the tomography waves 110 from the tomography wave generator 108 and generate resulting tomograms. Thus, the second UAV 104 is sometimes referred to herein as a tomography wave detecting UAV. In some examples, one or both UAVs 102, 104 include both a tomography wave generator 108 and a tomography wave detector 112 to function as either a tomography wave generating UAV or a tomography wave detecting UAV. In some such examples, the tomography wave generator 108 and a tomography wave detector 112 are incorporated into a single tomography device carried by the UAV.

As shown in the illustrated example, a tomogram of the structure 106 may be captured by positioning the UAVs 102, 104 on either side of the structure 106 so that the tomography waves 110 from the tomography wave generator 108 pass through the structure 106 and are received by the tomography wave detector 112. In the illustrated example, the structure 106 is a wind turbine. However, the teachings disclosed herein may be applied to any other suitable structure that is located in an area accessible by the UAVs 102, 104 and narrow enough to enable the UAVs 102, 104 to fly on either side at a distance within the range of the tomography wave generator and detector 108, 112. Other example structures include bridges, powerline towers, girders of under construction buildings, outdoor walls, piping and other equipment on oil platforms, radio masts and towers, etc.

In some examples, multiple tomograms of the structure 106 are captured from different angles as the UAVs 102, 104 change position and/or move relative to the structure 106. In some examples, continuous or substantially continuous tomographic measurements of the structure 106 are taken as the UAVs 102, 104 move relative to the structure 106 to capture the entire exterior and interior shape and/or construction of at least a segment of the structure 106 (e.g., one of the turbine blades in the illustrated example). In some examples, this information may be used to generate a three-dimensional (3D) volume model of the segment of the structure 106.

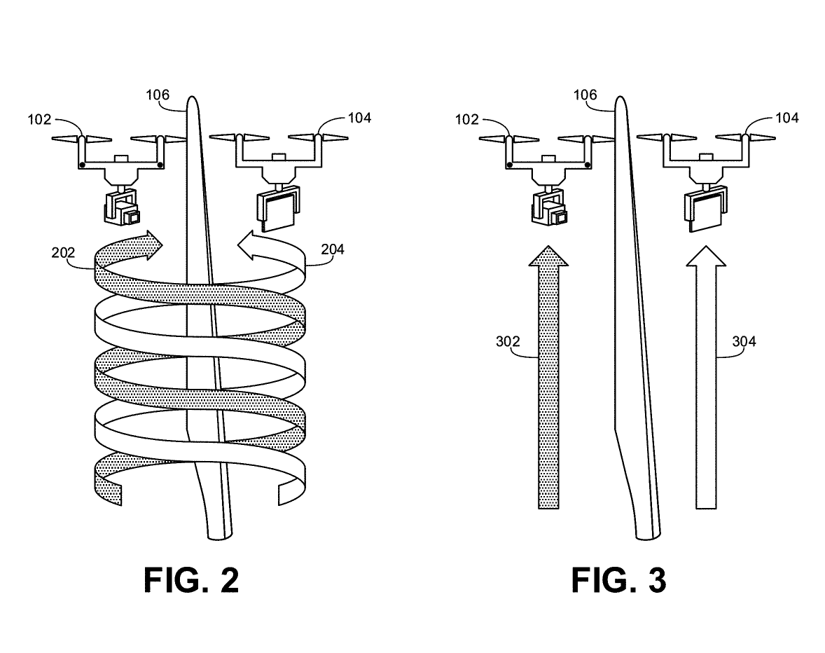

In some examples, the UAVs 102, 104 may rotate (represented by the arrows 114, 116 shown in FIG. 1) circumferentially around a longitudinal axis of the structure 106 to image a specific location of the structure 106 from different angles. In some examples, as represented by the arrows 202, 204 of FIG. 2, circumferential rotation of the UAVs 102, 104 about the structure 106 is combined with longitudinal movement along the axis or length of the structure 106 (e.g., defining a helical path) to image the entire volume of an extended segment of the structure 106. In some examples, as represented by the arrows 302, 304 of FIG. 3, the UAVs 102, 104 may move longitudinally along (e.g., parallel to) the axis or length of the structure 106 without circumferentially rotating about the axis to capture an image of an extended segment of the structure 106 from a specific angle. In some examples, multiple longitudinal passes along the length of the structure 106, with the UAVs 102, 104 at different circumferential positions about the axis, may be captured and combined to generate a 3D volume model of the structure 106. Any other suitable flight pattern may also be used to capture tomograms of the structure 106. Further, in some examples, more than two UAVs may be employed each with a corresponding flight path to more efficiently capture tomograms of the structure 106. For example, two pairs of UAVs 102, 104 may surround the structure 106 at different circumferential positions such that each pair of UAVs 102, 104 capture tomograms from a different angle than the other pair. In other examples, multiple pairs of UAVs 102, 104 may be controlled to capture tomograms of different portions of the structure 106 (e.g., a separate pair of UAVs for each of the turbine blades shown in FIG. 1).

In some examples, the tomography wave generator 108 and the tomography wave detector 112 may be affixed to the respective first and second UAVs 102, 104 to point in a substantially fixed direction relative to UAVs 102, 104. In such examples, the movement of the UAVs 102, 104 controls the movement of the tomography wave generator 108 and the tomography wave detector 112 and, thus, the angle at which tomograms of the structure 106 are captured. In some examples, the tomography wave generator 108 and the tomography wave detector 112 are attached to UAVs 102, 104 via corresponding gimbal systems 118, 120. In some examples, the gimbal systems 118, 120 serve to stabilize the tomography wave generator 108 and the tomography wave detector 112. Additionally or alternatively, the gimbal systems 118, 120 enable the tomography wave generator 108 and the tomography wave detector 112 to be rotated relative to the corresponding UAV 102, 104 for greater control in the direction in which the tomography wave generator 108 and the tomography wave detector 112 are facing.

In the illustrated examples, of FIGS. 1-3, the turbine blade of the structure 106 being imaged is oriented vertically. The vertical orientation of the turbine blade enables the UAVs 102, 104 to fly circumferentially around the blade with the tomography wave generator 108 and the tomography wave detector 112 facing toward the blade with a clear line-of-sight at every angle. Some structures may be oriented partially or completely horizontally (e.g., if the wind turbine of FIG. 1 were rotated by 90 degrees). In such situations, as the UAVs 102, 104 fly underneath the structure, the motors, propellers, frame, and/or other portions of the UAVs 102, 104 may obstruct the line of sight of the tomography wave generator 108 and the tomography wave detector 112. This problem may be partially overcome by adjusting the position of the tomography wave generator 108 and the tomography wave detector 112 relative to the UAVs 102, 104 via the gimbal system 118, 120.

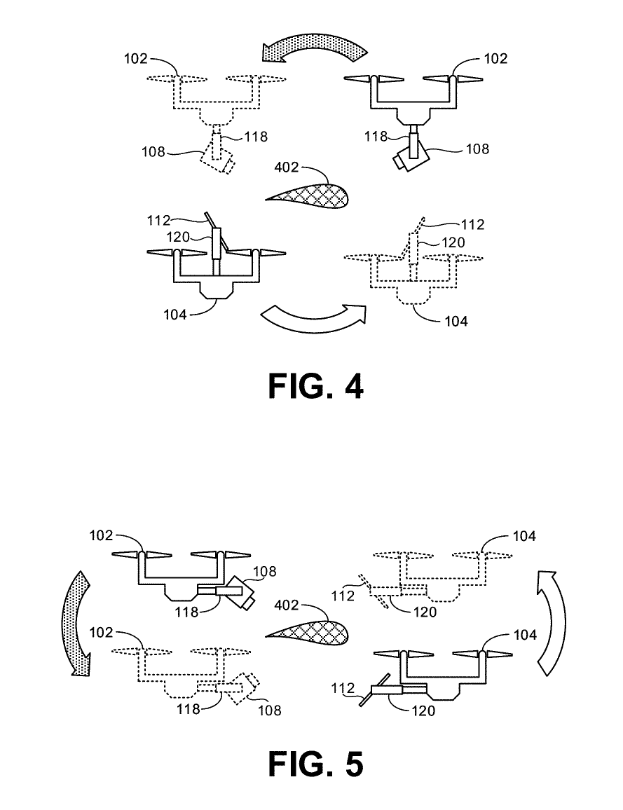

In other examples, the problem of the UAVs 102, 104 obstructing the line-of-sight of the tomography wave generator and detector 108, 112 may be overcome by placing the tomography wave generator and detector 108, 112 at different locations on the respective UAVs 102, 104. For example, FIG. 4 illustrates a cross-section of a turbine blade 402 that is extended horizontally (e.g., into the drawing) with the first UAV 102 flying above the blade 402 and the second UAV 104 flying underneath the blade 402. In the illustrated example of FIG. 4, the tomography wave generator 108 is attached to the bottom side of the first UAV 102 (similar to FIGS. 1-3) but the tomography wave detector 112 is attached to the upper side of the second UAV 104. In other examples, the position of the tomography wave generator and detector 108, 112 relative to the corresponding UAV 102, 104 may be reversed. As shown in the illustrated example, as the UAVs 102, 104 move relative to the turbine blade 402 (e.g., from the position represented in solid lines to the position represented in broken lines), the tomography wave generator 108 and the tomography wave detector 112 rotate on their respective gimbal systems 118, 120. In other examples, the tomography wave generator and detector 108, 112 may be placed to a side of the UAVs 102, 104 with the gimbal systems 118, 120 angling the tomography wave generator and detector 108, 112 up or down based on the position of the UAVs 102, 104 as shown in the illustrated example of FIG. 5. Other positions and/or movement of the tomography wave generator and detector 108, 112 relative to the respective UAVs 102, 104 may also be applied to implement the teachings disclosed herein.

Examples disclosed herein depend on the position and/or movement of the UAVs 102, 104 being precisely coordinated so as to maintain alignment between the tomography wave generator 108 and the tomography wave detector 112 with the structure 106 positioned therebetween. In some examples, this is achieved by autonomously controlling the UAVs 102, 104 according to stored flight plans associated with the structure 106 using real time kinematic (RTK) satellite navigation. RTK navigation can provide location accuracy to within less than an inch. In some examples, global positioning system (GPS) navigation may provide sufficient location accuracy.

In some examples, each UAV 102, 104 is controlled according to a separate, though complementary, flight plan. That is, in some examples, the UAVs 102, 104 may have no information concerning the location or flight path of the other UAV. In such examples, the synchronized movement of the UAVs 102, 104 is the result of the complementary flight plan being followed by each UAV. In some such examples, in addition to precisely controlling the position and movement of the UAVs 102, 104, the timing of such movement also needs to be synchronized so that both UAVs 102, 104 are at the right place at the right time. In some examples, this is achieved using a remote server 122 in communication with each of the UAVs 102, 104. In some examples, the timing of the UAVs 102, 104 may be synchronized using GPS timing.

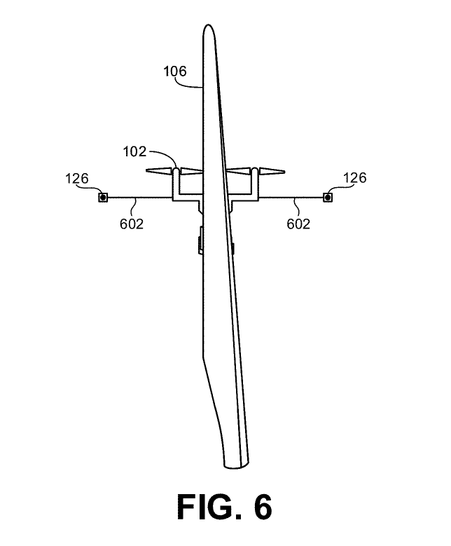

Additionally or alternatively, in some examples, one or both of the UAVs 102, 104 may determine the location of the other UAV while in flight to adjust their flight paths accordingly to synchronize the position and movement of the UAVs. This may be accomplished by information relayed via the remote server 122. In other examples, this is accomplished via wireless communications directly between the UAVs 102, 104. In other examples, as shown in FIGS. 1-3, one or both of the UAVs 102, 104 is equipped with a color image sensor 124 (e.g., a camera) that may be used to detect (using computer vision algorithms) color markers 126 positioned on the other one of the UAVs 102, 104. In some such examples, the image analysis facilitates the precise aiming of the tomography wave generator 108 and/or the precise positioning of the tomography wave detector 112 (e.g., based on movement of the UAVs 102, 104 and/or movement of the corresponding gimbal systems 118, 120). In some examples, as illustrated in FIG. 6, the markers 126 may be attached to arms 602 extending from a main body of the UAVs 102, 104 to be visible even when the structure 106 is positioned between the UAVs 102, 104 to obstruct a direct line-of-sight between the main bodies of the UAVs 102, 104. Although the arms 602 are shown in FIG. 6 to extend outward in a horizontal direction, the arms 602 may extend vertically or in any other direction. Furthermore, there may be any suitable number of arms 602 with any suitable number of markers 126.

Additionally or alternatively, in some examples, the tomography wave detecting UAV 104 may implement substantially real-time analysis of the tomography waves detected by the tomography wave detector 112 to dynamically adjust the position of the tomography wave detecting UAV 104 and/or the position of the tomography wave detector 112 relative to the tomography wave detecting UAV 104.

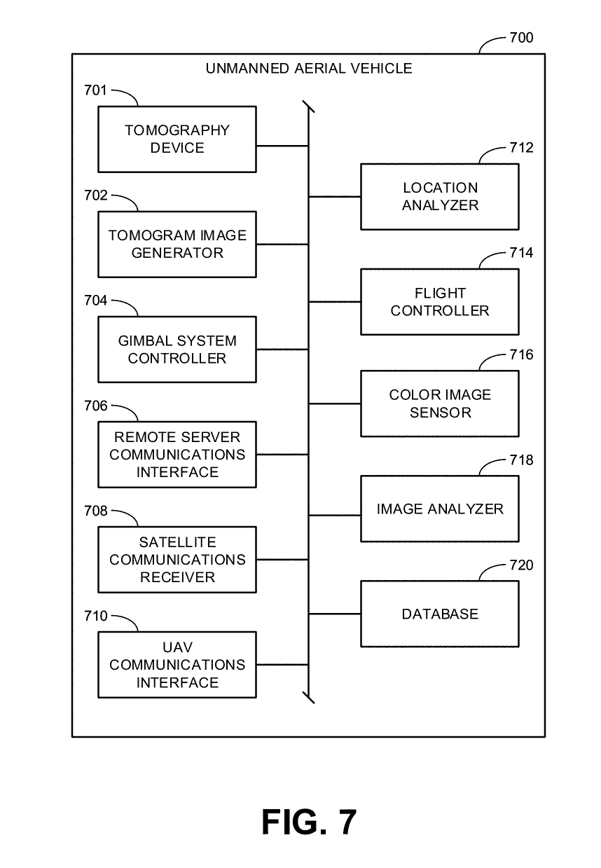

FIG. 7 is a block diagram illustrating an example implementation of a UAV 700 corresponding to either of the example UAVs 102, 104 of FIG. 1-6. The example UAV 700 of FIG. 7 includes an example tomography device 701, an example tomogram generator 702, an example gimbal system controller 704, an example remote server communications interface 706, an example satellite communications receiver 708, an example UAV communications interface 710, an example location analyzer 712, an example flight controller 714, an example color image sensor 716, an example image analyzer 718, and an example database 720.

The example tomography device 701 of the illustrated example may correspond to the tomography wave generator 108 (associated with the tomography wave generating UAV 102) or to the tomography wave detector 112 (associated with the tomography wave detecting UAV 104). In some examples, the tomography device 701 includes both tomography wave generating and tomography wave detecting functionality.

Although the example UAV 700 of FIG. 7 is shown to represent an example implementation of either of the UAVs 102, 104 of FIGS. 1-6, in some examples, one or more of the blocks shown in FIG. 7 may be included in only one of a corresponding pair of UAVs with other ones of the blocks limited to the other UAV. For instance, the example tomogram generator 702 serves to analyze tomography waves received by the tomography wave detector 112 to generate tomograms. Thus, the tomogram generator 702 may not be included in a UAV that does not include the tomography wave detector 112. In some examples, the tomogram generator 702 combines multiple tomograms and/or a continuous stream of tomographic measurements into a 3D volume model of the structure 106. In some examples, the tomograms and/or resulting 3D models are stored in the example database 720.

In the illustrated example, the gimbal system controller 704 serves to control the gimbal system (e.g., the gimbal systems 118, 120 of FIG. 1) used to stabilize and/or move the tomography device 701 relative to the UAV 700.

In the illustrated example, the remote server communications interface 706 enables communications between the UAV 700 and the remote server 122. In some examples, communications with the remote server 122 enable the synchronization of the UAV 700 with a second UAV. The satellite communications receiver 708 of the illustrated example serves to receive satellite communications that may be served to determine the time and/or the location of the UAV 700 to enable precise control of the UAV 700. In the illustrated example, the UAV communications interface 710 enables communications between the UAV 700 and a second UAV. In some examples, such communications are accomplished via short range radio transmissions.

The location analyzer 712 of the illustrated example serves to determine the location of the UAV 700 at any given point in time. In some examples, location is determined based on GPS signals received by the example satellite communications receiver 708. In some examples, the location analyzer 712 implements RTK navigation based on received satellite signals for increased accuracy in determining the location of the UAV 700. In the illustrated example, the flight controller 714 uses location information generated by the location analyzer 712 along with a flight plan to control the movement of the UAV 700. In some examples, the flight plan may include or be associated with information indicating the timing and/or location when tomograms are to be transmitted (by the tomography wave generating UAV) or received (by the tomography wave detecting UAV). The flight plan may be stored in the example database 720.

In the illustrated example, the color image sensor 716 serves to capture color images (e.g., photographs) of the area surrounding the UAV 700. In some examples, the color image sensor 716 is a camera. The example image analyzer 718 of the illustrated example may analyze color images captured by the color image sensor 716 to generate feedback to the example flight controller 714 and/or the gimbal system controller 704 to adjust a position of the UAV 700 and/or a position of the tomography device 701. More particularly, in some examples, the color image sensor 716 of the UAV 700 is to capture images of a second UAV that has markers 126 placed thereon. Using image analysis, the image analyzer 718 may identify the markers 126 to determine a position of the second UAV (and/or, more precisely, a tomography device 701 carried on the second UAV) relative to the UAV 700.

While an example manner of implementing the UAVs 102, 104 of FIG. 1-6 is represented by the example UAV 700 illustrated in FIG. 7, one or more of the elements, processes and/or devices illustrated in FIG. 7 may be combined, divided, re-arranged, omitted, eliminated and/or implemented in any other way. Further, the example tomogram generator 702, the example gimbal system controller 704, the example remote server communications interface 706, the example satellite communications receiver 708, the example UAV communications interface 710, the example location analyzer 712, the example flight controller 714, the example color image sensor 716, the example image analyzer 718, the example database 720, and/or, more generally, the example UAV 700 of FIG. 7 may be implemented by hardware, software, firmware and/or any combination of hardware, software and/or firmware. Thus, for example, any of the example tomogram generator 702, the example gimbal system controller 704, the example remote server communications interface 706, the example satellite communications receiver 708, the example UAV communications interface 710, the example location analyzer 712, the example flight controller 714, the example color image sensor 716, the example image analyzer 718, the example database 720, and/or, more generally, the example UAV 700 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example tomogram generator 702, the example gimbal system controller 704, the example remote server communications interface 706, the example satellite communications receiver 708, the example UAV communications interface 710, the example location analyzer 712, the example flight controller 714, the example color image sensor 716, the example image analyzer 718, and/or the example database 720 is/are hereby expressly defined to include a non-transitory computer readable storage device or storage disk such as a memory, a digital versatile disk (DVD), a compact disk (CD), a Blu-ray disk, etc. including the software and/or firmware. Further still, the example UAVs 102, 104 of FIGS. 1-6 may include one or more elements, processes and/or devices in addition to, or instead of, those illustrated in FIG. 7, and/or may include more than one of any or all of the illustrated elements, processes and devices.

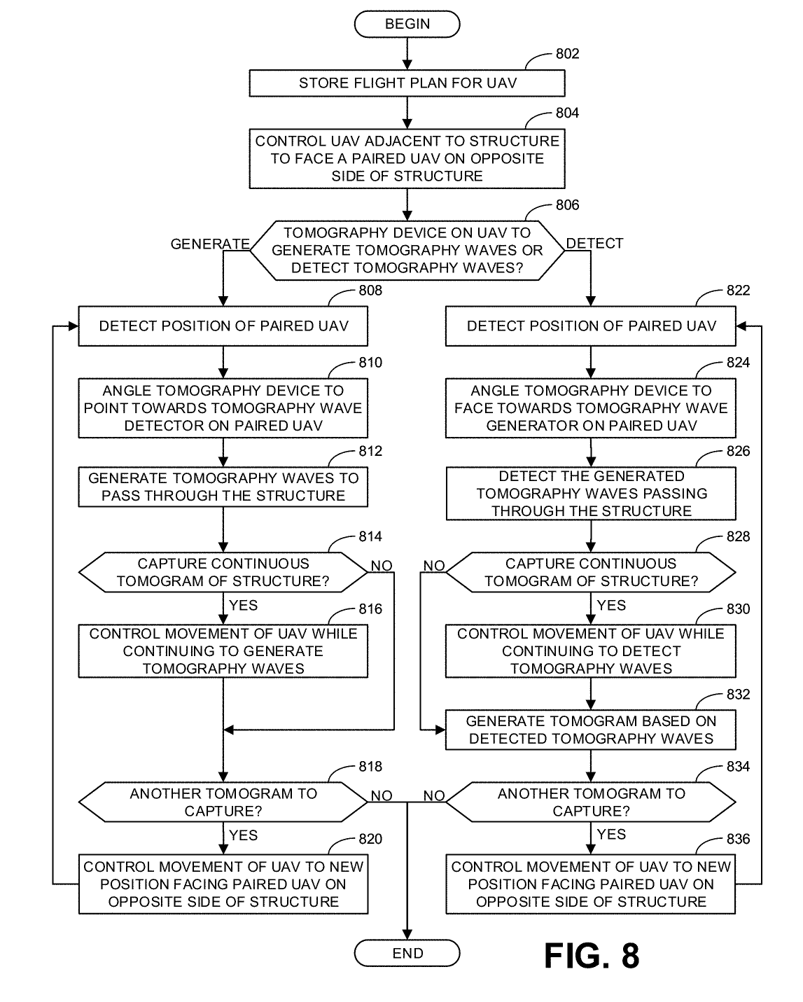

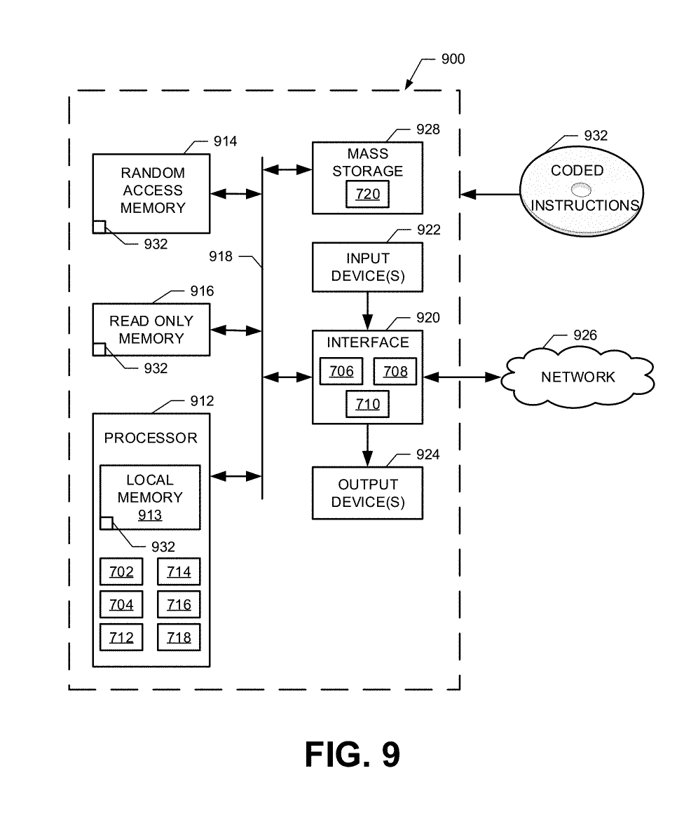

A flowchart representative of example machine readable instructions for implementing the UAVs 102, 104, 700 of FIGS. 1-7 is shown in FIG. 8. In this example, the machine readable instructions comprise a program for execution by a processor such as the processor 912 shown in the example processor platform 900 discussed below in connection with FIG. 9. The program may be embodied in software stored on a non-transitory computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 8, many other methods of implementing the example UAVs 102, 104, 700 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example process of FIG. 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

The example program of FIG. 8 may be simultaneously implemented in a pair of two UAVs, one of which is a tomography wave generating UAV 102 and the other is a tomography wave detecting UAV 104. For purposes of explanation, FIG. 8 will be described with reference to the example UAV 700, which may serve as either the tomography wave generating UAV 102 or the tomography wave detecting UAV 104.

The program of FIG. 8 begins at block 802 where the example database 720 stores a flight plan for the UAV 700. At block 804, the example flight controller 714 controls the UAV 700 adjacent to a structure (e.g., the structure 106 of FIG. 1) to face a second, paired UAV on an opposite side of the structure 106. The paired UAV corresponds to the other UAV in the pair of UAVs simultaneously implementing the example program. At block 806, the example process determines whether a tomography device 701 on the UAV 700 is to generate tomography waves (e.g., operate as the tomography wave generator 108) or to detect tomography waves (e.g., operate as the tomography wave detector 112). Whichever function (wave generating or wave detecting) the tomography device 701 of the UAV 700 corresponds to, the paired UAV is configured with a complementary tomography device that performs the opposite function.

If the tomography device 701 is to generate tomography waves (that is, the tomography device 701 corresponds to the tomography wave generator 108), control advances to block 808 where the example image analyzer 718 detects the position of the paired UAV (i.e., a tomography wave detecting UAV 104 in this instance) relative to the UAV 700. In some examples, the relative position of the paired UAV is based on detecting markers 126 on the paired UAV identified via an analysis of image data captured by the example color image sensor 716 of the UAV 700. At block 810, the example gimbal system controller 704 angles the tomography device 701 (operating as a tomography wave generator 108 in this instance) to point towards the tomography wave detector 112 on the paired UAV. In some examples, the precise direction in which the tomography device 701 is angled is based on the location of the paired UAV detected at block 808. At block 812, the example tomography device 701 generates tomography waves to pass through the structure 106. At block 814, the example flight controller 714 determines whether to capture a continuous tomogram of the structure 106. If so, control advances to block 816 where the example flight controller 714 controls movement of the UAV 700 while the tomography device 701 continues to generate tomography waves. Thereafter, control advances to block 818. If the example flight controller 714 determines not to capture a continuous tomogram of the structure 106 (block 814), control advances directly to block 818.

At block 818, the example flight controller 714 determines whether there is another tomogram to be captured. If so, control advances to block 820. Otherwise, the example program of FIG. 8 ends. At block 820, the example flight controller 714 controls movement of the UAV 700 to a new position facing the paired UAV on the opposite side of the structure 106. Thereafter, control returns to block 808 to repeat the process as described above.

Returning block 806, if the tomography device 701 is to detect tomography waves (that is, the tomography device 701 corresponds to the tomography wave detector 112), control advances to block 822 where the example image analyzer 718 detects the position of the paired UAV (i.e., a tomography wave generating UAV 102 in this instance) relative to the UAV 700. At block 824, the example gimbal system controller 704 angles the tomography device 701 (operating as a tomography wave detector 112 in this instance) to face towards the tomography wave generator 108 on the paired UAV. At block 826, the example tomography device 701 detects the tomography waves passing through the structure 106. At block 828, the example flight controller 714 determines whether to capture a continuous tomogram of the structure 106. If so, control advances to block 830 where the example flight controller 714 controls movement of the UAV 700 while the tomography device 701 continues to detect the generated tomography waves. Thereafter, control advances to block 832. If the example flight controller 714 determines not to capture a continuous tomogram of the structure 106 (block 828), control advances directly to block 832.

At block 832, the example tomogram generator 702 generates a tomogram based on the detected tomography waves. At block 834, the example flight controller 714 determines whether there is another tomogram to be captured. If so, control advances to block 836. Otherwise, the example program of FIG. 8 ends. At block 836, the example flight controller 714 controls movement of the UAV 700 to a new position facing the paired UAV on the opposite side of the structure 106. Thereafter, control returns to block 822 to repeat the process as described above.

As described above, blocks 808-820 are implemented by the UAV 700 when functioning as the tomography wave generating UAV 102 whereas blocks 822-836 are implemented when the UAV 700 is functioning as the tomography wave detecting UAV 104. In some examples, a UAV may be constructed to function exclusively as either the tomography wave generating UAV 102 or the tomography wave detecting UAV 104. In some such examples, the example program of FIG. 8 may be simplified by omitting either blocks 808-820 or blocks 822-836 based on the designated function of the UAV.

FIG. 9 is a block diagram of an example processor platform 900 capable of executing the instructions of FIG. 8 to implement the UAVs 102, 104, 700 of FIGS. 1-7. The processor platform 900 can be, for example, a server, a personal computer, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. The hardware processor may be a semiconductor based (e.g., silicon based) device. In this example, the processor implements the example tomogram generator 702, the example gimbal system controller 704, the example remote server communications interface 706, the example satellite communications receiver 708, the example UAV communications interface 710, the example location analyzer 712, the example flight controller 714, the example color image sensor 716, and the example image analyzer 718.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.). In this example, the interface circuit 920 implements the example remote server communications interface 706, the example satellite communications receiver 708, and the example UAV communications interface 710.

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives. In this example, the mass storage device 928 includes the example database 720.

The coded instructions 932 of FIG. 8 may be stored in the mass storage device 928, in the volatile memory 914, in the non-volatile memory 916, and/or on a removable tangible computer readable storage medium such as a CD or DVD.

From the foregoing, it will be appreciated that example methods, apparatus and articles of manufacture have been disclosed that enable synchronized control of two UAVs to either side of structure to enable tomographic imaging of the structure using complementary tomography devices (e.g., a tomography wave generator and a tomography wave detector) carried by different ones of the two UAVs. Disclosed examples enable the scanning and imaging of the inside of structures to provide more detail regarding the structural integrity of objects than is possible using traditional visual inspections limited to an exterior of the structure. Furthermore, continuous tomographic imaging of a structure may be performed to capture an entire volume of at least an extended segment of the structure.

Example 1 is an apparatus that includes a flight controller, implemented by at least one processor, to control a first unmanned aerial vehicle adjacent to a structure. The apparatus further includes a first tomography device mounted to the first unmanned aerial vehicle. The first tomography device is to at least one of (a) transmit tomography waves to or (b) detect tomography waves from a second tomography device mounted on a second unmanned aerial vehicle to generate a tomogram of the structure.

Example 2 includes the subject matter of Example 1, and further includes markers on the first unmanned aerial vehicle to be identified by an image sensor on the second unmanned aerial vehicle.

Example 3 includes the subject matter of Example 2, wherein the markers are attached to arms extending outward of a main body of the first unmanned aerial vehicle.

Example 4 includes the subject matter of Example 1, and further includes an image sensor to capture an image of the second unmanned aerial vehicle, and an image analyzer to identify markers on the second unmanned aerial vehicle to determine a position of the second unmanned aerial vehicle relative to a position of the first unmanned aerial vehicle.

Example 5 includes the subject matter of any one of Examples 1-4, and further includes a gimbal system to control an angle of the first tomography device relative to the first unmanned aerial vehicle.

Example 6 includes the subject matter of any one of Examples 1-5, wherein the first tomography device is to at least one of transmit or detect the tomography waves while the flight controller controls movement of the first unmanned aerial vehicle relative to the structure. The second unmanned aerial vehicle is to move in synchronization with the first unmanned aerial vehicle to maintain the structure between the first and second unmanned aerial vehicles.

Example 7 includes the subject matter of Example 6, wherein the first and second unmanned aerial vehicles are to follow circumferential paths about a longitudinal length of the structure.

Example 8 includes the subject matter of Example 6, wherein the first and second unmanned aerial vehicles are to follow helical paths about a longitudinal length of the structure.

Example 9 includes the subject matter of Example 6, wherein movement of the first and second unmanned aerial vehicles follow paths extending parallel to a longitudinal length of the structure.

Example 10 includes the subject matter of any one of Examples 1-9, wherein the tomogram is a first tomogram captured when the first unmanned aerial vehicle is in a first position relative to the structure. The flight controller is to control movement of the first unmanned aerial vehicle to a second position relative to the structure to enable the first and second tomography devices to capture a second tomogram to combine with the first tomogram to form a three-dimensional model of the structure.

Example 11 includes the subject matter of any one of Examples 1-10, wherein the first tomography device is a tomography wave detector to detect the tomography waves from the second tomography device. The apparatus further includes a tomogram generator in communication with the tomography wave detector to generate the tomogram based on the detected tomography waves passing through the structure.

Example 12 includes the subject matter of any one of Examples 1-10, wherein the first tomography device is a tomography wave generator to generate the tomography waves transmitted to the second tomography device.

Example 13 includes the subject matter of any one of Examples 1-12, wherein the tomography waves correspond to x-rays.

Example 14 includes the subject matter of any one of Examples 1-12, wherein the apparatus is part of a system that includes the first unmanned aerial vehicle, and the second unmanned aerial vehicle. The first and second unmanned aerial vehicles are to follow respective first and second flight paths that position the structure between the first and second unmanned aerial vehicles.

Example 15 is a non-transitory computer readable medium, comprising instructions that, when executed, cause a machine to at least control a first unmanned aerial vehicle adjacent to a structure. The instructions are further to cause the machine to, with a first tomography device on the first unmanned aerial vehicle, at least one of (a) transmit tomography waves to or (b) detect tomography waves from a second tomography device on a second unmanned aerial vehicle to generate a tomogram of the structure.

Example 16 includes the subject matter of Example 15, wherein the instructions further cause the machine to determine a position of the second unmanned aerial vehicle relative to a position of the first unmanned aerial vehicle.

Example 17 includes the subject matter of Example 16, wherein the position of the second unmanned aerial vehicle is determined based on wireless communications between the first unmanned aerial vehicle and the second unmanned aerial vehicle.

Example 18 includes the subject matter of Example 16, wherein the instructions further cause the machine to capture, with an image sensor on the first unmanned aerial vehicle, an image of the second unmanned aerial vehicle. The instructions further cause the machine to identify markers on the second unmanned aerial vehicle based on an analysis of the image. The instructions further cause the machine to determine the position of the second unmanned aerial vehicle based on the image analysis.

Example 19 includes the subject matter of any one of Examples 16-18, wherein the instructions further cause the machine to adjust, via a gimbal system, an angle of the first tomography device based on the position of the second unmanned aerial vehicle.

Example 20 includes the subject matter of any one of Examples 15-19, wherein the instructions further cause the machine to at least one of transmit or detect, with the first tomography device, the tomography waves while moving the first unmanned aerial vehicle relative to the structure. The second unmanned aerial vehicle moves in synchronization with the first unmanned aerial vehicle to enable transmission of the tomography waves between the first and second tomography devices to pass through the structure.

Example 21 includes the subject matter of Example 20, wherein movement of the first and second unmanned aerial vehicles follow circumferential paths about a longitudinal length of the structure.

Example 22 includes the subject matter of Example 20, wherein movement of the first and second unmanned aerial vehicles follow helical paths about a longitudinal length of the structure.

Example 23 includes the subject matter of Example 20, wherein movement of the first and second unmanned aerial vehicles follow paths extending parallel to a longitudinal length of the structure.

Example 24 includes the subject matter of any one of Examples 15-23, wherein the tomogram is a first tomogram. The instructions further cause the machine to move the first unmanned aerial vehicle to a new position adjacent to the structure to enable the first and second tomography devices to capture a second tomogram. The first and second tomograms to be combined to form a three-dimensional model of the structure.

Example 25 includes the subject matter of any one of Examples 15-24, wherein the first tomography device is a tomography wave detector detecting the tomography waves from the second tomography device. The instructions further cause the machine to generate the tomogram based on the detected tomography waves passing through the structure.

Example 26 includes the subject matter of any one of Examples 15-25, wherein the tomography waves correspond to x-rays.

Example 27 is a method that includes controlling, by executing an instruction on at least one processor, a first unmanned aerial vehicle adjacent to a structure. The method further includes, with a first tomography device on the first unmanned aerial vehicle, at least one of (a) transmitting tomography waves to or (b) detecting tomography waves from a second tomography device on a second unmanned aerial vehicle to generate a tomogram of the structure.

Example 28 includes the subject matter of Example 27, and further includes determining a position of the second unmanned aerial vehicle relative to a position of the first unmanned aerial vehicle.

Example 29 includes the subject matter of Example 28, wherein the position of the second unmanned aerial vehicle is determined based on wireless communications between the first unmanned aerial vehicle and the second unmanned aerial vehicle.

Example 30 includes the subject matter of Example 28, and further includes capturing, with an image sensor on the first unmanned aerial vehicle, an image of the second unmanned aerial vehicle. The method also includes identifying markers on the second unmanned aerial vehicle based on an analysis of the image. The method further includes determining the position of the second unmanned aerial vehicle based on the image analysis.

Example 31 includes the subject matter of any one of Examples 28-30, and further includes adjusting, via a gimbal system, an angle of the first tomography device based on the position of the second unmanned aerial vehicle.

Example 32 includes the subject matter of any one of Examples 27-31, and further includes at least one of transmitting or detecting, with the first tomography device, the tomography waves while moving the first unmanned aerial vehicle relative to the structure. The second unmanned aerial vehicle moves in synchronization with the first unmanned aerial vehicle to enable transmission of the tomography waves between the first and second tomography devices to pass through the structure.

Example 33 includes the subject matter of Example 32, wherein movement of the first and second unmanned aerial vehicles follow circumferential paths about a longitudinal length of the structure.

Example 34 includes the subject matter of Example 32, wherein movement of the first and second unmanned aerial vehicles follow helical paths about a longitudinal length of the structure.

Example 35 includes the subject matter of Example 32, wherein movement of the first and second unmanned aerial vehicles follow paths extending parallel to a longitudinal length of the structure.

Example 36 includes the subject matter of any one of Examples 27-35, wherein the tomogram is a first tomogram. The method further includes moving the first unmanned aerial vehicle to a new position adjacent to the structure to enable the first and second tomography devices to capture a second tomogram. The first and second tomograms are to be combined to form a three-dimensional model of the structure.

Example 37 includes the subject matter of any one of Examples 27-36, wherein the first tomography device is a tomography wave detector detecting the tomography waves from the second tomography device. The method further includes generating the tomogram based on the detected tomography waves passing through the structure.

Example 38 includes the subject matter of any one of Examples 27-37, wherein the tomography waves correspond to x-rays.

Example 39 is a machine readable medium including code that, when executed, causes a machine to perform the method as defined in any one of Examples 27-38.

Example 40 a method that includes controlling a first unmanned aerial vehicle adjacent to a structure. The method further includes controlling a second unmanned aerial vehicle adjacent to the structure. The first and second unmanned aerial vehicles follow respective first and second flight paths that position the structure between the first and second unmanned aerial vehicles. The method further includes generating tomography waves with a tomography wave generator on the first unmanned aerial vehicle. The tomography waves are directed to pass through the structure toward a tomography wave detector on the second unmanned aerial vehicle. The method further includes generating a tomogram of the structure based on the tomography waves detected by the tomography wave detector.

Example 41 includes the subject matter of Example 40, and further includes transmitting communications between the first and second unmanned aerial vehicles to determine a position of a first one of the first or second unmanned aerial vehicles relative to a position of a second one of the at least one of the first or second unmanned aerial vehicles.

Example 42 includes the subject matter of Example 41, and further includes capturing, with an image sensor on a first one of the first or second unmanned aerial vehicles, an image of a second one of the first or second unmanned aerial vehicles. The method further includes identifying markers on the second one of the first or second unmanned aerial vehicles based on an analysis of the image. The method also includes determining a position of the second one of the first or second unmanned aerial vehicles relative to the first one of the first or second unmanned aerial vehicles based on the image analysis.

Example 43 includes the subject matter of Example 42, and further includes adjusting, via a gimbal system, an angle of a first one of the tomography wave generator or the tomography wave detector associated with the first one of the first or second unmanned aerial vehicles based on the position of the second one of the first or second unmanned aerial vehicles.

Example 44 includes the subject matter of any one of Examples 40-43, and further includes moving the first and second unmanned aerial vehicles along the respective first and second flight paths while generating the tomography waves.

Example 45 includes the subject matter of any one of Examples 40-43, wherein the first and second flight paths include circumferential paths about a longitudinal length of the structure.

Example 46 includes the subject matter of any one of Examples 40-43, wherein the first and second flight paths include helical paths about a longitudinal length of the structure.

Example 47 includes the subject matter of any one of Examples 40-43, wherein the first and second flight paths extend parallel to a longitudinal length of the structure.

Example 48 includes the subject matter of any one of Examples 40-47, wherein the tomogram is a first tomogram captured when the first and second unmanned aerial vehicles are at first positions adjacent the structure. The method further includes moving the first and second unmanned aerial vehicles to second positions adjacent the structure to capture a second tomogram. The method also includes combining the first and second tomograms to form a three-dimensional model of the structure.

Example 49 includes the subject matter of any one of Examples 40-48, wherein the tomography waves correspond to x-rays.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus, comprising:
a flight controller, implemented by at least one processor, to control a first unmanned aerial vehicle adjacent to a structure; and
a first tomography device mounted to the first unmanned aerial vehicle, the first tomography device to at least one of (a) transmit tomography waves to or (b) detect tomography waves from a second tomography device mounted on a second unmanned aerial vehicle to generate a tomogram of the structure.

2. The apparatus as defined in claim 1, further including markers on the first unmanned aerial vehicle to be identified by an image sensor on the second unmanned aerial vehicle.

3. The apparatus as defined in claim 2, wherein the markers are attached to arms extending outward of a main body of the first unmanned aerial vehicle.

4. The apparatus as defined in claim 1, further including;
an image sensor to capture an image of the second unmanned aerial vehicle; and
an image analyzer to identify markers on the second unmanned aerial vehicle to determine a position of the second unmanned aerial vehicle relative to a position of the first unmanned aerial vehicle.

5. The apparatus as defined in claim 1, further including a gimbal system to control an angle of the first tomography device relative to the first unmanned aerial vehicle.

6. The apparatus as defined in claim 1, wherein the first tomography device is to at least one of transmit or detect the tomography waves while the flight controller controls movement of the first unmanned aerial vehicle relative to the structure, the second unmanned aerial vehicle to move in synchronization with the first unmanned aerial vehicle to maintain the structure between the first and second unmanned aerial vehicles.

7. The apparatus as defined in claim 6, wherein the first and second unmanned aerial vehicles are to follow circumferential paths about a longitudinal length of the structure.

8. The apparatus as defined in claim 6, wherein the first and second unmanned aerial vehicles are to follow helical paths about a longitudinal length of the structure.

9. The apparatus as defined in claim 6, wherein movement of the first and second unmanned aerial vehicles follow paths extending parallel to a longitudinal length of the structure.

10. The apparatus as defined in claim 1, wherein the tomogram is a first tomogram captured when the first unmanned aerial vehicle is in a first position relative to the structure, the flight controller to control movement of the first unmanned aerial vehicle to a second position relative to the structure to enable the first and second tomography devices to capture a second tomogram to combine with the first tomogram to form a three-dimensional model of the structure.

11. The apparatus as defined in claim 1, wherein the first tomography device is a tomography wave detector to detect the tomography waves from the second tomography device, the apparatus further including a tomogram generator in communication with the tomography wave detector to generate the tomogram based on the detected tomography waves passing through the structure.

12. The apparatus as defined in claim 1, wherein the first tomography device is a tomography wave generator to generate the tomography waves transmitted to the second tomography device.

13. The apparatus as defined in claim 1, wherein the apparatus is part of a system including:
the first unmanned aerial vehicle; and
the second unmanned aerial vehicle, the first and second unmanned aerial vehicles to follow respective first and second flight paths that position the structure between the first and second unmanned aerial vehicles.

14. A non-transitory computer readable medium, comprising instructions that, when executed, cause a machine to at least:
control a first unmanned aerial vehicle adjacent to a structure; and
with a first tomography device on the first unmanned aerial vehicle, at least one of (a) transmit tomography waves to or (b) detect tomography waves from a second tomography device on a second unmanned aerial vehicle to generate a tomogram of the structure.

15. The non-transitory computer readable medium as defined in claim 14, wherein the instructions further cause the machine to determine a position of the second unmanned aerial vehicle relative to a position of the first unmanned aerial vehicle.

16. The non-transitory computer readable medium as defined in claim 15, wherein the instructions further cause the machine to:
capture, with an image sensor on the first unmanned aerial vehicle, an image of the second unmanned aerial vehicle;
identify markers on the second unmanned aerial vehicle based on an analysis of the image; and
determine the position of the second unmanned aerial vehicle based on the analysis of the image.

17. The non-transitory computer readable medium as defined in claim 14, wherein the instructions further cause the machine to at least one of transmit or detect, with the first tomography device, the tomography waves while moving the first unmanned aerial vehicle relative to the structure, the second unmanned aerial vehicle moving in synchronization with the first unmanned aerial vehicle to enable transmission of the tomography waves between the first and second tomography devices to pass through the structure.

18. The non-transitory computer readable medium as defined in claim 14, wherein the tomogram is a first tomogram, the instructions further causing the machine to:
move the first unmanned aerial vehicle to a new position adjacent to the structure to enable the first and second tomography devices to capture a second tomogram, the first and second tomograms to be combined to form a three-dimensional model of the structure.

19. A method, comprising:
controlling, by executing an instruction on at least one processor, a first unmanned aerial vehicle adjacent to a structure; and
with a first tomography device on the first unmanned aerial vehicle, at least one of (a) transmitting tomography waves to or (b) detecting tomography waves from a second tomography device on a second unmanned aerial vehicle to generate a tomogram of the structure.

20. The method as defined in claim 19, further including at least one of transmitting or detecting, with the first tomography device, the tomography waves while moving the first unmanned aerial vehicle relative to the structure, the second unmanned aerial vehicle moving in synchronization with the first unmanned aerial vehicle to enable transmission of the tomography waves between the first and second tomography devices to pass through the structure.

21. A method, comprising:
controlling a first unmanned aerial vehicle adjacent to a structure;
controlling a second unmanned aerial vehicle adjacent to the structure, the first and second unmanned aerial vehicles following respective first and second flight paths that position the structure between the first and second unmanned aerial vehicles;
generating tomography waves with a tomography wave generator on the first unmanned aerial vehicle, the tomography waves directed to pass through the structure toward a tomography wave detector on the second unmanned aerial vehicle; and
generating a tomogram of the structure based on the tomography waves detected by the tomography wave detector.

22. The method as defined in claim 21, further including:
capturing, with an image sensor on a first one of the first or second unmanned aerial vehicles, an image of a second one of the first or second unmanned aerial vehicles;
identifying markers on the second one of the first or second unmanned aerial vehicles based on an analysis of the image; and
determining a position of the second one of the first or second unmanned aerial vehicles relative to the first one of the first or second unmanned aerial vehicles based on the analysis of the image.
